(19) United States
(12) Patent Application Publication
(10) Pub. No.: US 2013/0255153 A1
(43) Pub. Date: Oct. 3, 2013

(54) Method of Gas Purification, Coal Gasification Plant, and Shift Catalyst

(71) Applicant: HITACHI, LTD., Tokyo (JP)

(72) Inventors: Takashi SASAKI, Hitachinaka-shi (JP); Tomoko AKIYAMA, Hitachinaka-shi (JP)

(73) Assignee: HITACHI, LTD., Tokyo (JP)

(21) Appl. No.: 13/771,456

(22) Filed: Feb. 20, 2013

(30) Foreign Application Priority Data
Mar. 30, 2012 (JP) 2012-079874

(51) Int. Cl. B01J 27/19; C10J 3/82

(52) U.S. Cl. CPC B01J 27/19; C10J 3/82
USPC 48/101; 48/128; 502/211

(57) ABSTRACT

Disclosed is a method of gas purification, a coal gasification plant, and a shift catalyst, each of which enables an inexpensive treatment of condensed water derived from steam used in a CO shift reaction. A CO shift reaction is performed using a shift catalyst less causing side reactions (e.g., a P—Mo—Ni-supported shift catalyst), and condensed water derived from steam used in the CO shift reaction is reused or treated. The method includes a cleaning step of removing water-soluble substances from a gasified gas containing CO and H₂S; a CO shift step of allowing CO in a gas after the cleaning step to react with steam by the catalysis of the shift catalyst to convert CO into CO₂ and H₂; and a recovery step of removing CO₂ and H₂S from a gas after the CO shift step, in which post-shift condensed water formed after the CO shift step is recycled.

### TECHNICAL FIELD

The present invention relates to a method of gas purification, a coal gasification plant, and a shift catalyst. Specifically, the present invention relates to a method of gas purification, a coal gasification plant, and a shift catalyst, each of which relates to the purification of a gasified gas which is produced through gasification of coal or another carbon-containing solid fuel and which contains CO and H₂S.

### CLAIM OF PRIORITY

The present application claims priority from Japanese Patent application serial No. 2012-79874, filed on Mar. 30, 2012, the content of which is hereby incorporated by reference into this application.

### BACKGROUND ART

A power generation technique called integrated coal gasification combined cycle (IGCC) has recently received attention. This technique employs coal as a fuel because coal is available in large reserves and can be stably supplied in future. In the technique, coal is once gasified in a gasification furnace to give a gasified gas, and the gasified gas is supplied as a fuel for power generation.

In addition, a CO₂ recovery IGCC technique has been developed to reduce CO₂ emissions from power plants so as to prevent global warming. In this technique, carbon monoxide (CO) in a gasified gas is converted into CO₂ through a CO shift reaction, and resulting CO₂ is recovered. Such gasified gas from a gasification furnace contains sulfur components such as H₂S and COS, and to endure these sulfur components, sulfur-tolerant CO shift catalysts have been developed. Typically, PCT International Publication Number WO 2011/105501 A1 (PTL 1) discloses a CO shift catalyst which includes active ingredients including one of molybdenum (Mo) and iron (Fe) as a principal component and one of nickel (Ni) and ruthenium (Ru) as an accessory component; and one or more oxides of titanium (Ti), zirconium (Zr), and cerium (Ce) as a support supporting the active ingredients.

### CITATION LIST

### Patent Literature

[PTL 1] WO 2011/105501 A1

### SUMMARY OF INVENTION

### Technical Problem

The CO shift reaction requires steam (water vapor). In IGCC plants, part of steam to be supplied to a steam turbine is generally extracted and supplied to a shift reaction. Accordingly, reduction in steam supply to the shift reaction is effective for increasing the plant efficiency. WO 2011/105501 A1 (PTL 1) describes that one of oxides of Ti, Zr, and Ce, when used as the support, provides a catalyst having a satisfactory activity at low temperatures; and that the catalyst allows a CO shift reaction to proceed efficiently even when the steam supply is reduced.

Condensed water derived from steam used in the CO shift reaction (i.e., condensed water derived from unutilized steam and formed upon cooling of a gas which has been subjected to the shift reaction) contains impurities and is drained after being purified typically for the prevention of environmental pollution. Such IGCC plants are now in a demonstration phase, but not yet in a commercial phase. If IGCC plants are commercially launched, the treatment for drainage of condensed water derived from steam used in the CO shift reaction also comes to an issue. Customary techniques, including the technique disclosed in WO 2011/105501 A1 (PTL 1), lack particular consideration of the treatment of condensed water derived from steam used in the CO shift reaction. In the commercial phase, however, increase in cost of a system for the treatment of the condensed water to be drained should be avoided.

The coal gasification plants are used not only for power generation but also for the production of H₂ serving as a starting material for chemical products. The treatment for drainage of condensed water becomes an issue also in plants for producing chemical products from coal.

An object of the present invention is to provide a method of gas purification, a coal gasification plant, and a shift catalyst, each of which enables inexpensive treatment of condensed water derived from steam used in a CO shift reaction.

### Solution to Problem

The present invention performs a CO shift reaction in the presence of a shift catalyst hardly causing a side reaction, and reuses, or treats for drainage, condensed water derived from steam used in the CO shift reaction.

The present invention also provides a shift catalyst which includes a support; and phosphorus (P), molybdenum (Mo), and nickel (Ni) each supported on the support.

### Advantageous Effects of Invention

The present invention applies a shift catalyst hardly causing a side reaction to a shift reaction so as to reduce impurities contained in condensed water derived from steam used in the shift reaction and thereby enables an inexpensive treatment of the condensed water derived from the steam used in the CO shift reaction.

Further objects, features, and advantages of the present invention will become apparent from the following description of the preferred embodiments with reference to the attached drawings.

### BRIEF DESCRIPTION OF DRAWINGS

FIG. 1 is a flow chart of a gas purification system in a coal gasification plant according to an embodiment of the present invention;

FIG. 2 is a block flow diagram of an integrated coal gasification combined cycle power plant system to which an embodiment of the present invention is applied;

FIG. 3 is a block flow diagram of a gas purification system in a coal gasification plant according to an embodiment of the present invention;

FIG. 4 is a diagram illustrating a pressurization testing equipment used for the determination of performance of shift catalysts;

FIG. 5 is a diagram illustrating an atmospheric testing equipment used for the determination of performance of shift catalysts;

FIG. 6 is a graph illustrating results of Test Example 1 for the determination of performance of shift catalysts and indicating how the CO conversion varies depending on the type of a support;

FIG. 7 is a graph illustrating results of Test Example 2 for the determination of performance of shift catalysts and indicating how the CO conversion varies depending on the ratio of Mo to Ti (Mo/T);

FIG. 8 is a graph illustrating results of Test Example 3 for the determination of performance of shift catalysts and indicating how the CO conversion varies depending on the ratio of Ni to Ti (Ni/Ti);

FIG. 9 is a graph illustrating results of Test Example 4 for the determination of performance of shift catalysts and indicating how the CO conversion varies depending on the ratio of phosphorus (P) to Ti (P/Ti);

FIG. 10 is a graph illustrating results of Test Example 5 for the determination of performance of shift catalysts and indicating how the CO conversion under a pressurized condition varies depending on the temperature;

FIG. 11 is a graph illustrating results of Test Example 6 for the determination of performance of shift catalysts and indicating how the CO conversion under a pressurized condition varies depending on the ratio of H₂O to CO(H₂O/CO); and

FIG. 12 is a graph illustrating results of Test Example 7 for the determination of performance of shift catalysts and indicating how side products are generated depending on the type of the catalyst.

### DESCRIPTION OF EMBODIMENTS

Embodiments of the present invention will be illustrated below with reference to the attached drawings.

Initially, how the present invention has been made will be described prior to the detailed description of embodiments of the present invention.

A gasified gas from a gasification furnace includes sulfur components such as H₂S and COS. Cu—Zn catalysts and Fe—Cr catalysts are known as catalysts for accelerating shift reactions. These catalysts are poisoned by such sulfur components and thereby require a desulphurization operation arranged upstream from them.

Sulfur-tolerant shift catalysts, represented by Co—Mo catalysts, have also been developed as catalysts for accelerating shift reactions. Such sulfur-tolerant shift catalysts do not exhibit CO shift activities unless H₂S is coexistent in the gas. Co—Mo catalysts exhibit CO shift activities within a wide temperature range, but have higher reaction starting temperatures than those of Cu—Zn catalysts. The shift reaction represented by Formula (1) becomes resistant to proceed at an elevating temperature in relation with chemical equilibrium and is accelerated by supplying steam in excess to CO (by supplying steam in a stoichiometric ratio or more).

CO+H₂O→CO₂+H₂ (1)

In thermal power plants, part of steam to be supplied to a steam turbine is generally extracted and used as steam to be supplied to the shift reaction. The steam supply to the shift reaction should therefore be reduced in order to prevent power generation efficiency from decreasing.

However, reduction in steam supply to the shift reaction may reduce the selectivity for the shift reaction, and this may cause side reactions other than the shift reaction to proceed. Typical side reactions as expected from components contained in the gas gasified from coal include reactions represented by Formulae (2), (3), and (4):

nCO+(2n+1)H₂→CₙH₂ₙ₊₂+nH₂O (2)

2CO→C+CO₂ (3)

CO+2H₂→CH₃OH (4)

The reaction represented by Formula (2) is a reaction called Fischer-Tropsch reaction, in which hydrocarbons are produced from CO and H₂. The production of hydrocarbons has following disadvantages. A first disadvantage is that CO is converted not into CO₂ but into hydrocarbons, and this reduces the amount of recovered CO₂. A second disadvantage is that the produced hydrocarbons are cracked to form solid carbon that deposits on the catalyst, and this may reduce the activity of the catalyst.

The reaction represented by Formula (3) is a reaction called Boudoir reaction, in which CO decomposes into solid carbon and CO₂. The solid carbon, if deposited on the catalyst, may reduce the activity of the catalyst, as mentioned above.

The reaction represented by Formula (4) is a methanol synthesis reaction. Alcohols typified by methanol are soluble in water and are dissolved in condensed water which is derived from unutilized steam and is generated upon cooling of the gas having been subjected to the shift reaction. The steam to be supplied to the shift catalyst is extracted from the steam to be supplied to the steam turbine, as mentioned above. However, the condensed water containing impurities such as alcohols is not reusable as water to be supplied to the steam generator and should therefore be treated as waste water. This increases not only water supply cost but also waste water treatment cost.

Reduction in amount of generated condensed water and reduction in amounts of impurities contained in the condensed water are effective for the reduction of waste water treatment.

The reduction in amount of generated condensed water may be achieved by allowing a shift reaction to be accelerated even with a small steam supply. Such reduction in amount of the steam to be supplied to the shift reaction is also effective for the recovery of CO₂ while suppressing power generation efficiency in thermal power plants from decreasing, as described above.

In view of chemical equilibrium, the shift reaction should be performed at a low temperature so as to reduce the steam supply. Specifically, the steam supply can be reduced by employing a catalyst having a lower reaction starting temperature while utilizing such a feature of the shift reaction that it readily proceeds at a lower temperature in view of chemical equilibrium.

In contrast, reduction of amounts of impurities contained in the condensed water has been regarded as not especially related to improvements in power generation efficiency of thermal power plants and has not been considered. In particular, the amounts of side products such as alcohols formed in the shift reaction has not been investigated in relation to waste water treatment. Reduction of side products in the condensed water derived from steam that has been subjected to the shift reaction, when achieved, may mitigate environmental loads and enable not only reduction of waste water treatment cost, but also a recycling system of condensed water derived from steam that has been subjected to the shift reaction. Specifically, the present inventors focused attention on reduction of side products in the shift reaction.

The reduction of steam supply to the shift reaction may possibly increase the selectivity of side reactions other than the shift reaction to cause side products, as described above. Of side products, alcohols and organic acids are dissolved in the condensed water derived from steam that has been subjected to the shift reaction and cause the waste water treatment cost to increase.

The present inventors made investigations and found that a sulfur-tolerant shift catalyst, when elaborated, can have a lower reaction starting temperature and can contribute to higher selectivity for the shift reaction even with a small steam supply and thereby prevent side reactions from proceeding. Preferred examples of the sulfur-tolerant shift catalyst will be illustrated in detail later. The sulfur-tolerant shift catalyst mentioned above, when applied to the shift reaction, enables the reduction in steam supply to the shift reaction and the reduction in amounts of side products contained in the condensed water derived from steam that has been subjected to the shift reaction. The present inventors also found that the configuration enables reuse (recycling) of condensed water derived from steam that has been subjected to the shift reaction typically as water to be supplied to the steam generator. Specifically, they found that the configuration enables a recycling system of condensed water derived from steam that has been subjected to the shift reaction, which recycling system has not been considered until now.

<Shift Catalyst>

Next, a shift catalyst preferred for a method and system of gas purification according to the present invention will be illustrated below.

Initially, test examples for the determination of effects of shift catalysts will be explained.

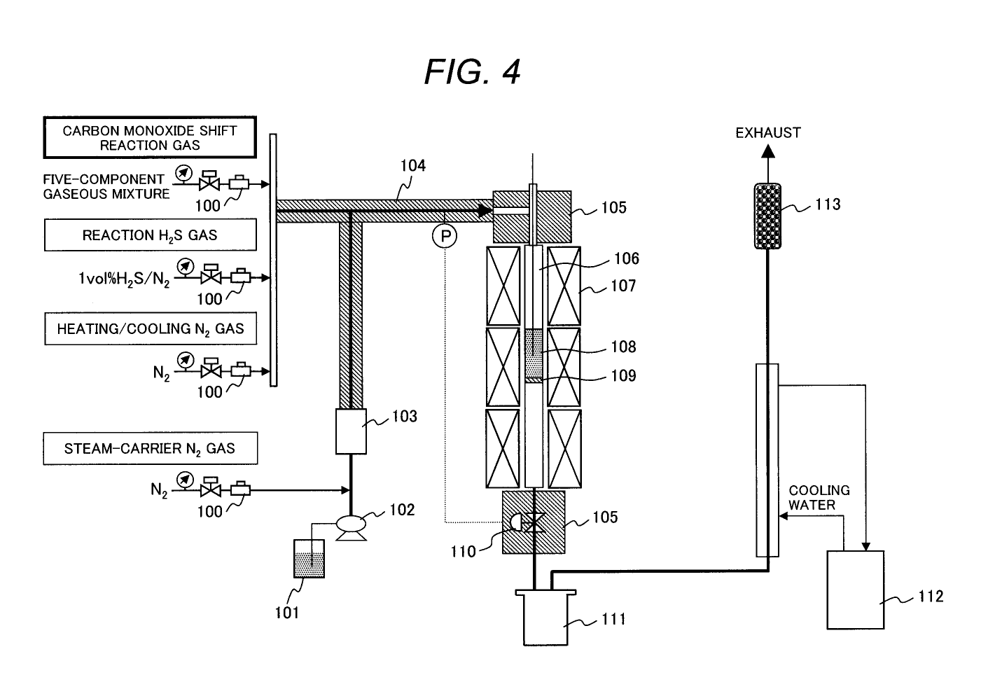

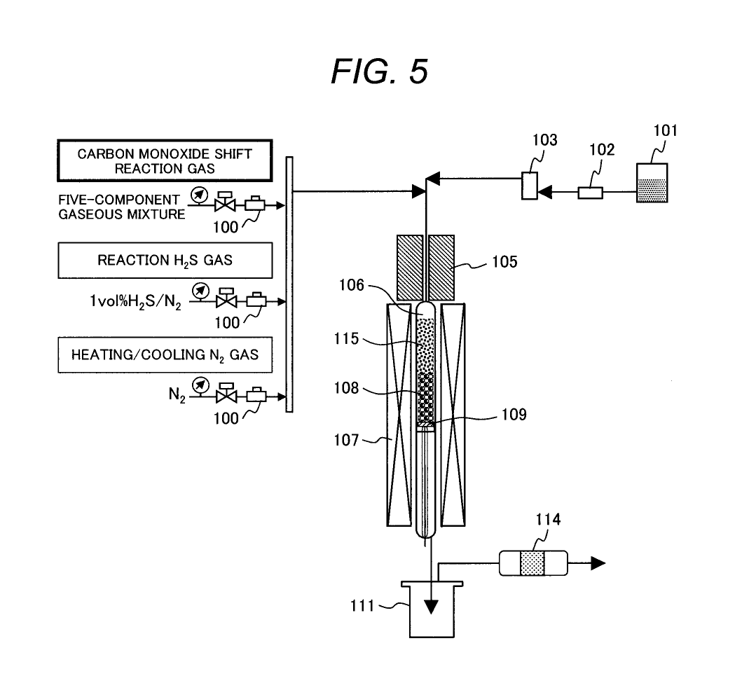

In these test examples, atmospheric testing equipment was used for screening catalysts; and pressurization testing equipment was used for simulating conditions of actual equipment. The pressurization testing equipment for determination of catalytic performance and the atmospheric testing equipment for determination of catalytic performance are illustrated in FIG. 4 and FIG. 5, respectively.

The two equipment has similar basic structures and each includes a gas supply system (a mass-flow controller 100), a steam supply system (a water tank 101, a plunger pump 102, and a water vaporizer 103), a tubular reactor 106, an electric furnace 107, and a trapping tank 111. The electric furnace 107 changes the reaction temperature in the tubular reactor 104. The trapping tank 111 condenses water in a gas and traps the condensed water. The pressurization testing equipment for determination of catalytic performance further includes a water remover (chiller) 112; and the atmospheric testing equipment for determination of catalytic performance further includes a moisture absorber 114 filled with magnesium perchlorate, each of which completely removes water in the gas.

As reaction gases simulating a gasified gas, CO, H₂, CH₄, CO₂, N₂, and H₂S were supplied to the tubular reactor 106, whose flow rates were controlled to predetermined levels by the mass-flow controller 100. Water in the water tank 101, with control of its flow rate by the plunger pump 102, was supplied to and vaporized in the water vaporizer 103, and the resulting steam was supplied to the tubular reactor 106. The pressurization testing equipment for determination of catalytic performance further included a line heater 104 around the piping for supplying the reaction gasses and steam to the tubular reactor 106; and a mantle heater 105 around the upper part of the tubular reactor each for conserving heat so as to prevent condensation of the vaporized steam.

The pressurization testing equipment for determination of catalytic performance further includes a pressure-control valve 110 arranged below the tubular reactor 106. The pressure in the piping for supplying the reaction gases and steam to the tubular reactor 106 was measured, based on which the opening of the pressure-control valve 110 was controlled. Thus, the inside of the tubular reactor was pressurized to simulate conditions in a gas purification system of an actual integrated coal gasification combined cycle power plant, and properties of catalysts under pressure (at 2.4 MPa G (gauge)) were evaluated.

A perforated plate was placed in the tubular reactor 106, a glass wool 109 was spread over the perforated plate, over which a test catalyst 108 was charged. The atmospheric testing equipment for determination of catalytic performance had a higher gas linear velocity than that of the pressurization testing equipment for determination of catalytic performance and thereby included a Raschig ring 115 as a rectifier over the test catalyst 108.

Performance of test catalysts were tested and evaluated under the following conditions. Sulfur-tolerant shift catalysts were charged as oxides into the tubular reactor, and Mo in the catalysts had to be reduced by a sulfurization-reduction operation represented by Reaction Formula (5) before use.

MoO₃+2H₂S+H₂→MoS₂+3H₂O (5)

In a nitrogen (N₂) stream, the temperature was raised to a catalyst temperature of 180° C. The gas was then changed to a gaseous mixture of N₂ containing 7 percent by volume of H₂, followed by temperature rise to 200° C. After the temperature became steady, H₂S was supplied in a flow rate of 3 percent by volume with regulation. After checking the detection of H₂S at a catalytic layer outlet, the temperature was raised to 320° C. at a rate of 1° C./min and held to 320° C. for 45 minutes, whereby the sulfurization-reduction treatment was completed.

The testing gases used herein were a five-component gaseous mixture containing 60 percent by volume of CO, 20 percent by volume of H₂, 5 percent by volume of CO₂, 1 percent by volume of CH₄, and 14 percent by volume of N₂; and a gaseous mixture of N₂ with 1% H₂S. The catalyst was charged in such an amount that a space velocity (SV) in terms of a wet gas be 15,000 h⁻¹ in a pressurization test and be 1,400 h⁻¹ in a test under atmospheric pressure. The reactant H₂O was controlled and supplied so that the molar ratio of H₂O to CO(H₂O/CO) be from 1.2 to 1.8. A gas at the outlet of the catalytic layer was sampled, and a CO concentration therein was measured with a gas chromatograph. A CO conversion was calculated according to Formula (6):

CO conversion=1−[(Outlet CO flow rate)/(Inlet CO flow rate)]=1−[(Outlet CO concentration)×(Outlet gas flow rate)]/[(Inlet CO concentration)×(Inlet gas flow rate)] (6)

### Test Example 1

In this test example, Mo and Ni were supported on Al₂O₃, TiO₂, and ZrO₂ selected as catalyst supports to yield catalysts, and CO conversions of the catalysts were compared. The tests were performed under atmospheric pressure.

A way to prepare the catalysts will be illustrated below. The test catalysts were each prepared by kneading, but may be prepared typically by impregnation or coprecipitation. The Ni/Mo/Al₂O₃ source was 40 g of pseudoboehmite (AlO(OH)_{1.2}H₂O (trade name: PURAL SB1; CONDEA Chemie GmbH)) added with 5.17 g of ammonium heptamolybdate tetrahydrate and 14.23 g of nickel nitrate hexahydrate. The Ni/Mo/TiO₂ source was 40 g of titanium oxide (trade name: MC-150; ISHIHARA SANGYO KAISHA, LTD.) added with 4.47 g of ammonium heptamolybdate tetrahydrate and 14.86 g of nickel nitrate hexahydrate. The Ni/Mo/ZrO₂ source was 40 g of zirconium oxide (trade name: RSC-100; DAIICHI KIGENSO KAGAKU CO., LTD.) added with 4.34 g of ammonium heptamolybdate tetrahydrate and 14.45 g of nickel nitrate hexahydrate. These were combined with distilled water so that the total water amount including hydrates be 40 g, followed by wet-kneading in an automatic mortar for 30 minutes. Next, the kneadates were dried at 120° C. for 2 hours and fired at 500° C. for one hour. The fired catalysts were pulverized in a mortar and compacted under a pressure of 500 kgf for 2 minutes. The compacted catalysts were graded to 10 to 20 mesh and yielded test catalysts.

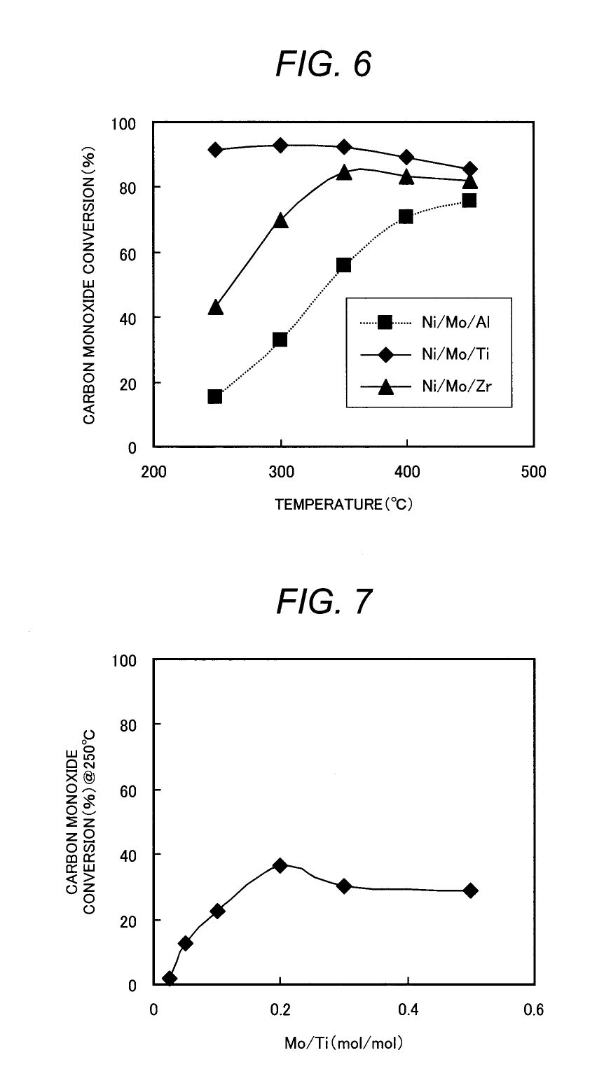

Temperature profiles of the prepared catalysts are indicated in FIG. 6. Catalysts using the TiO₂ and ZrO₂ supports had significantly higher activities than that of a catalyst using the Al₂O₃ support at any temperature range. Among them, a Ni/Mo/TiO₂ catalyst had an activity of 91.3% at a low temperature of 250° C., which is higher than that of a Ni/Mo/Al₂O₃ catalyst by about 75 points. These supports function as a base or matrix for maintaining dispersion of microparticles by the action of interactions with the active ingredients (Ni and Mo). This test example was performed to examine the three supports to find that the TiO₂-supported catalyst had a highest activity. This indicates that the TiO₂ support exhibited highest dispersibility of microparticles.

These results demonstrate that a catalyst including Ni and Mo supported on TiO₂ exhibited a highest activity at low temperatures, as a catalyst for accelerating a shift reaction in coexistence with H₂S. Such TiO₂ support may be combined with one or more other supporting components such as ZrO₂ and Al₂O₃.

### Test Example 2

This test example was performed in order to optimize the compositional ratio of Ni/Mo/TiO₂ catalysts which had been verified in Test Example 1 to have significantly higher activities at low temperatures. Initially, the compositional ratio of Mo to Ti in Mo/TiO₂ catalysts was optimized.

Test catalysts were prepared in the following manner. The test catalysts were each prepared by kneading. To 40 g of titanium oxide (trade name: MC-150; ISHIHARA SANGYO KAISHA, LTD.) was added ammonium heptamolybdate tetrahydrate in such amounts that the metal molar ratio of Mo to Ti (Mo/Ti) be 0.025, 0.05, 0.1, 0.2, 0.3, and 0.5, respectively. The resulting mixtures were wet-kneaded, followed by the procedure of Test Example 1 to give test catalysts.

FIG. 7 illustrates how the CO conversion at 250° C. varies depending on the Mo/Ti ratio in the test catalysts. The tests were performed at atmospheric pressure. The results indicate that the CO conversion reached a maximum at a Mo/Ti ratio of 0.2. A composition with a Mo/Ti ratio of 0.2 was defined as an optimal composition, because the composition exhibited a higher activity at a low temperature, which is advantageous in the present invention. Catalysts having a composition with a Mo/Ti ratio of 0.05 or less had a CO conversion of 20% or less and failed to give a sufficient conversion. This is probably because the amount of Mo acting as an active ingredient is insufficient at such a low Mo/Ti ratio to cause a low CO conversion. In contrast, at an excessively high Mo/Ti ratio, Mo microparticles may probably disperse not so well on the support and undergo sintering upon preparation to reduce catalytic sites. In consideration of these, the Mo/Ti ratio is preferably from 0.1 to 0.5 so as to give a sufficient CO conversion of more than 20%. The test catalyst appeared to have a low CO conversion of 20%, but the catalyst, when further containing Ni, could exhibit a sufficient CO conversion of about 90% as illustrated in FIG. 6.

### Test Example 3

This test example was performed so as to optimize the Ni content using, as a base composition, the composition with a Mo/Ti ratio of 0.2 as optimized in Test Example 2.

Test catalysts were prepared in the following manner. The test catalysts were each prepared by kneading. To 40 g of titanium oxide (trade name: MC-150; ISHIHARA SANGYO KAISHA, LTD.) were added ammonium heptamolybdate tetrahydrate and nickel nitrate hexahydrate in such amounts that the metal molar ratio of Mo, Ni, and Ti (Mo:Ni:Ti) be 0.2:0.05:1, 0.2:0.1:1, 0.2:0.2:1, and 0.2:0.3:1, respectively. The resulting mixtures were wet-kneaded, followed by the procedure of Test Example 1 to give test catalysts.

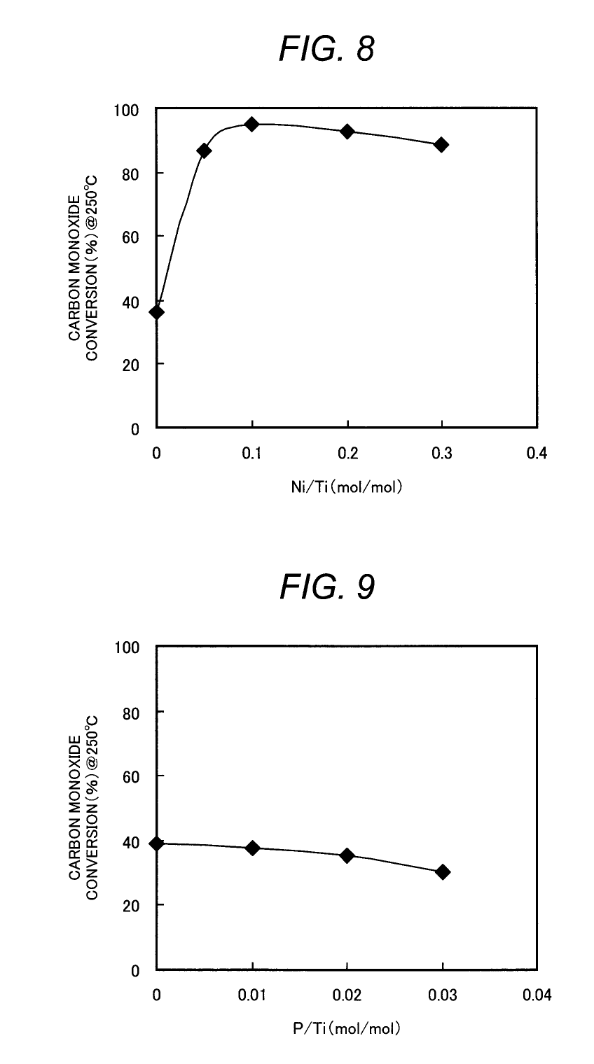

FIG. 8 illustrates how the CO conversion at 250° C. varies depending on the Ni/Ti ratio in the test catalysts. The tests were performed at atmospheric pressure. The result of a catalyst having a Ni/Ti ratio of 0 is also indicated in FIG. 8. The results indicate that the CO conversion had a maximum at a compositional Ni/Ti ratio of 0.1; and that the CO conversion was sufficiently high at Ni/Ti ratios in the range of 0.05 to 0.3.

The results in Test Examples 2 and 3 demonstrate that a catalyst prepared as to have a compositional ratio of Ni:Mo:Ti of 0.1:0.2:1 exhibited a highest activity. Nickel (Ni) in the catalyst probably has the function of accelerating the reduction-sulfurization reaction of Mo. Nickel, if in a high content, is present in the vicinity of Mo or is combined with Mo to accelerate the reduction-sulfurization reaction of Mo. However, if Ni is used in a content at a certain level or more, Ni that has not been combined with Mo aggregates, and the aggregated Ni may probably cover Mo acting as catalytic sites or clog pores to cause a lower activity. The optimal composition is preferred in terms of initial activity, because catalysts with Ni/Ti ratios of 0.1 or more had substantially equivalent initial CO conversions. However, Ni which has not been compounded with Mo in early stages can be compounded with Mo during long-term usage. In this case, it is also recommended to use a catalyst having a Ni/Ti ratio of from 0.2 to 0.5.

### Test Example 4

This test example was performed to examine effects of phosphorus from the viewpoint of CO conversion, which phosphorus was added to the catalyst having the composition optimized in Test Example 3.

Test catalysts used in this test example were prepared by adding phosphorus to, as a base catalyst, the Ni/Mo/TiO₂ catalyst having the compositional ratio optimized in Test Example 3. Phosphorus herein was added so that P/Ti molar ratios be from 0.01 to 0.03. The test catalysts were prepared by kneading upon which phosphoric acid was added in predetermined amounts so as to give the molar ratios.

FIG. 9 illustrates how the CO conversion at 250° C. varies depending on the P/Ti ratio in the test catalysts. The tests were performed at atmospheric pressure. The result of a catalyst having a P/Ti ratio of 0 is also indicated in FIG. 9. The results demonstrate that the CO conversion decreased with an increasing P content. Phosphorus (P) in the catalysts probably has the function of maintaining a MoS₂ structure formed as a result of the reduction-sulfurization treatment. In Ni—Mo catalysts after the reduction-sulfurization treatment, Ni—Mo—S form a bridge structure. Phosphorus probably stabilizes the Ni—Mo—S structure and maintains the selectivity for the shift reaction. The stabilization of the Ni—Mo—S structure by the presence of phosphorus can also be expected in other supports, such as ZrO₂ and Al₂O₃, than TiO₂.

If the Ni—Mo—S structure is broken and sulfurization of Mo is not maintained, the selectivity for the shift reaction may decrease, and this may invite not only a low shift activity but also higher selectivities of side reactions. In contrast, phosphorus, when added, may clog part of pores to reduce the initial activity of the shift reaction. The results in this test example demonstrate that phosphorus, when added in a small amount (in terms of P/Ti ratio of 0.02 or less, preferably 0.01 to 0.02), could maintain the selectivity for the selectivity for the shift reaction without adversely affecting the CO conversion; and that phosphorus, when added in a small amount, maintained the selectivity for the shift reaction and lowered the selectivities of side reactions. Side reaction inhibitory effects of phosphorus will be described later in Test Example 7.

### Test Example 5

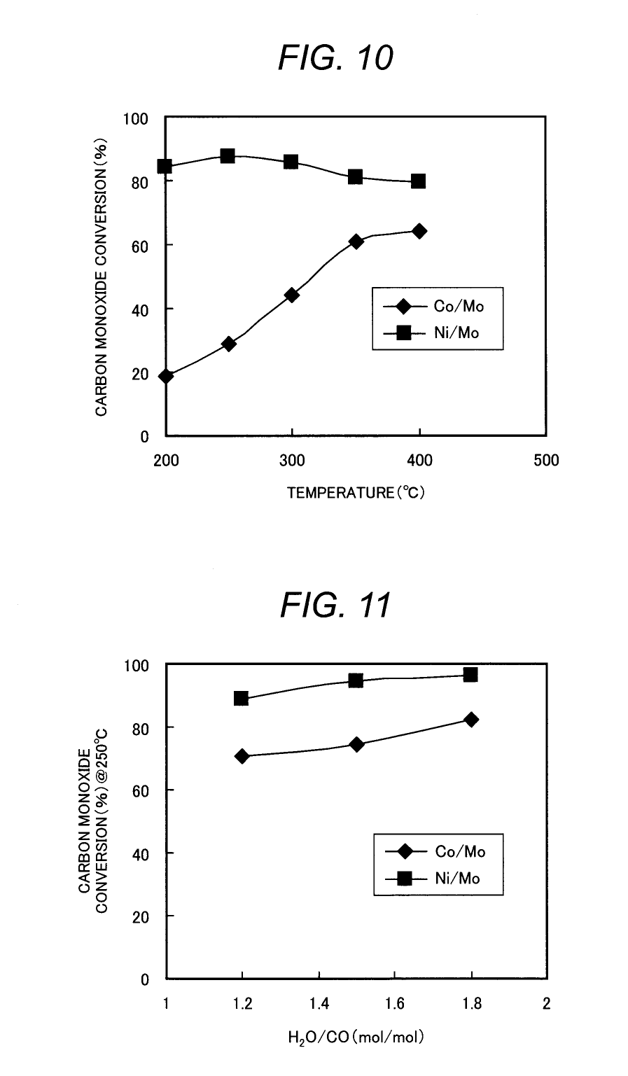

This test example was performed to examine how the property (CO conversion) of the catalyst having the composition optimized in Test Example 3 varies depending on the temperature in pressurization tests. A comparative catalyst was also examined herein. The comparative catalyst was prepared as a common Co—Mo catalyst having a CO content identical to the Ni content of the corresponding Ni—Mo catalyst. FIG. 10 illustrates how the CO conversion under pressurization varies depending on the temperature. The tests were performed at a space velocity (SV) of 15,000 h⁻¹ and a H₂O/CO ratio of 1.8. The results in this test example demonstrate that the optimized catalyst had a significantly higher activity at a low temperature than that of the Co—Mo catalyst.

### Test Example 6

This test example was performed to examine how the property (CO conversion) of the catalyst having the composition optimized in Test Example 3 varies depending on the H₂O/CO ratio in pressurization tests. A comparative catalyst was also examined herein. The comparative catalyst was prepared as a common Co—Mo catalyst having a CO content identical to the Ni content of the corresponding Ni—Mo catalyst. FIG. 11 illustrates how the CO conversion under pressurization varies depending on the H₂O/CO ratio. The tests were performed as pressurization tests at a space velocity SV of 1,400 h⁻¹ and a temperature of 250° C. The results in this test example demonstrate that the optimized catalyst exhibited a higher CO conversion activity than that of the Co—Mo catalyst even with a small steam supply; and that the Ni—Mo catalyst had a higher activity at a H₂O/CO ratio of 1.2 than that of the Co—Mo catalyst at a H₂O/CO ratio of 1.8.

### Test Example 7

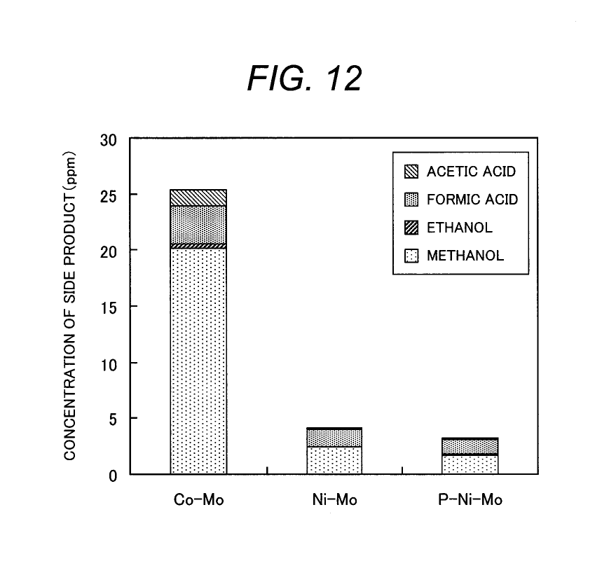

This test example was performed to examine how side products were formed in pressurization tests in a catalyst having the composition optimized in Test Example 3 and in a catalyst further containing phosphorus examined in Test Example 4. The latter catalyst contained phosphorus at a P/Ti ratio of 0.01. The test catalysts were subjected to continuous tests for 5 hours at a temperature of 400° C. and a H₂O/CO ratio of 1.2. Water-soluble substances in the gas after 5-hour test and in the condensed water were quantitatively analyzed. The tests were performed at a temperature of 400° C. because side products are liable to form at high temperatures, and the temperature at the catalyst layer outlet is about 400° C. A Co—Mo catalyst as a comparative catalyst was also subjected to the test. The results of the three catalysts are indicated in FIG. 12. Four water-soluble substances, i.e., methanol and ethanol as alcohols, and acetic acid and formic acid as organic acids were analyzed. The results in this test example demonstrate that the Ni—Mo catalyst could reduce the formation of side products in an amount about one-sixth that of the Co—Mo catalyst; and that the Ni—Mo catalyst, when further containing phosphorus, could further reduce the formation of side products in an amount about one-eighth that of the Co—Mo catalyst. In relation to catalytic components, the Ni—Mo catalyst and the P—Ni—Mo catalyst had methanol formation rates of 11.9% and 8.5%, respectively, as compared to that of the Co—Mo catalyst and exhibited the highest reduction in the methanol amount. The Ni—Mo catalyst had ethanol and formic acid formation rates of 24.3% and 43.9%, respectively, whereas the P—Ni—Mo catalyst had ethanol and formic acid formation rates of 16.3% and 38.0%, respectively, demonstrating that the addition of phosphorus significantly suppressed the formation of ethanol and formic acid. Only small amounts of acetic acid were formed both in the Ni—Mo and P—Ni—Mo catalysts. The results apparently demonstrate that the addition of phosphorus could significantly inhibit the formation reactions of side products and allowed the shift reaction to proceed selectively.

The above results demonstrate that Ni—Mo and P—Ni—Mo catalysts had high activities at low temperatures, thus contributed not only to reduction in steam supply, but also to suppression of side reactions, and could thereby reduce the amounts of water-soluble substances, such as alcohols and organic acids, dissolved in the condensed water.

### First Embodiment

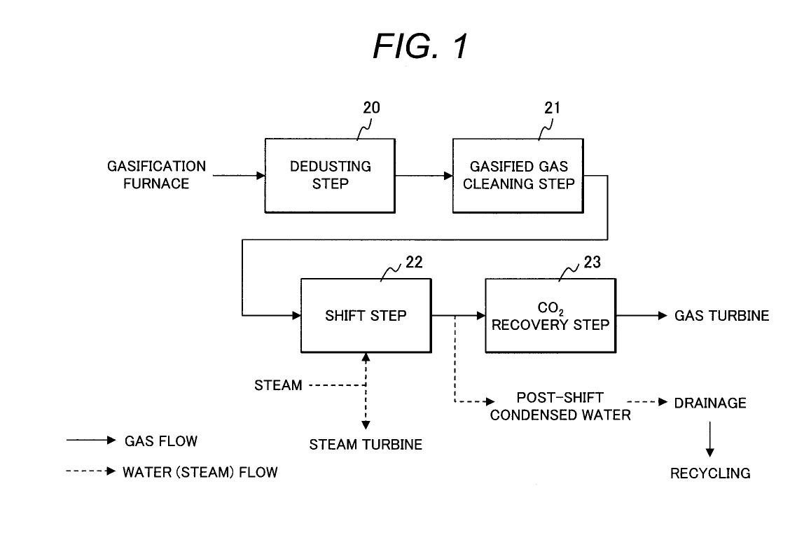

Next, a method/system of gas purification according to an embodiment of the present invention will be illustrated. FIG. 1 is a flow chart of a gas purification system in a coal gasification plant to which the present invention is applied. This embodiment may be applied to a gasified gas (a gas gasified from a solid fuel) containing at least CO and H₂S and basically employs a gasified gas cleaning step; a CO shift step; and a CO₂ recovery step. The gasified gas cleaning step removes water-soluble substances from the gasified gas. The CO shift step allows CO contained in a gas after the cleaning step to react with steam by the catalysis of a shift catalyst and thereby converts CO into CO₂ and H₂. The CO₂ recovery step removes CO₂ from a gas after the CO shift step. This embodiment also employs a shift catalyst which has a low reaction starting temperature, has high selectivity for the shift reaction, and less causes side reactions to proceed even with a small steam supply. In addition, the embodiment employs recycling of post-shift condensed water generated after the CO shift step.

Specifically, a gasified gas obtained through gasification of coal in a gasification furnace contains CO, H₂S and COS. The gasified gas is supplied through a dedusting step 20 and a gasified gas cleaning step 21 to a shift step 22. The shift step 22 employs the aforementioned shift catalyst which has a low reaction starting temperature, has high selectivity for the shift reaction, and less causes side reactions to proceed even with a small steam supply. The shift catalyst may be, but not limited to, a shift catalyst including a TiO₂ support and, supported thereon, P, Mo, and Ni. The shift catalyst can be any one, as long as being a sulfur-tolerant shift catalyst hardly causing side reactions to proceed. The shift step 22 converts CO in the gasified gas into CO₂ and H₂ through the reaction of Formula (1), using part of high-temperature steam (steam at a temperature of about 300° C. to about 350° C.) which is generated in a steam generator and supplied to a steam turbine. Finally, the CO₂ recovery step separates H₂ and CO₂ from the gasified gas, and the separated H₂ is supplied as a fuel gas to a gas turbine. The CO₂ recovery step also removes H₂S from the gasified gas. Condensed water (post-shift condensed water), which is derived from unutilized steam and is generated upon cooling of the gas having been subjected to the shift reaction, is supplied to a system in which the condensed water will be reused, such as the steam generator, and is thus recycled, or discharged to the outside without further treatment.

The coal gas contains a trace amount of COS. COS is converted into CO₂ and H₂S through the hydrolysis reaction represented by Formula (7), as with the CO shift reaction. Accordingly, the embodiment performs a COS conversion step using the same catalyst as the shift catalyst. Specifically, this embodiment converts both CO and COS in the shift reactor (shift step) without separately providing a COS converter (COS conversion step). However, the embodiment may be modified so as to further include a COS conversion step between the gasified gas cleaning step 21 and the shift step 22 so as to convert COS in the gasified gas into CO₂ and H₂S through the reaction represented by Formula (7):

COS+H₂0→CO₂+H₂S (7)

The specific shift catalyst, when used in the shift step 22, can reduce the supply of high-temperature and high-pressure steam to the shift reaction and can thereby suppress deterioration in power generation efficiency, as the specific shift catalyst has a low reaction starting temperature, has high selectivity for the shift reaction, and less causes side reactions to proceed even with a small steam supply. Reduction in steam supply to the shift reaction also reduces the amount of post-shift condensed water. The shift catalyst enables not only reduction in steam supply to the shift reaction but also suppression of side reactions to thereby reduce the concentrations of water-soluble substances in the condensed water. The resulting condensed water is less contaminated with side products and can be discharged without a further treatment. Such clean condensed water can be recycled typically as water to be supplied to the steam generator. When used as recycled water, the condensed water may be further subjected to a cleaning or purification treatment according to the amounts of side products therein. Typically, a chemical oxygen demand (COD) of the condensed water is measured with a COD sensor, and the condensed water is subjected to a water treatment step according to the cleanliness of the condensed water required in a system to which the condensed water is recycled. The water treatment step may employ a common water treatment process such as membrane cleaning, ozonolysis, or precipitation/filtration using a flocculant. The embodiment, even when further including the water treatment step, can perform the water treatment at low cost with a small load on the water treatment step, because the condensed water contains side products in small amounts. According to customary techniques, purification of condensed water to such an extent as to be reusable as water to be supplied to the steam generator is unthinkable in view of water treatment cost. However, the present invention enables reuse or recycle of the post-shift condensed water as water to be supplied to the steam generator.

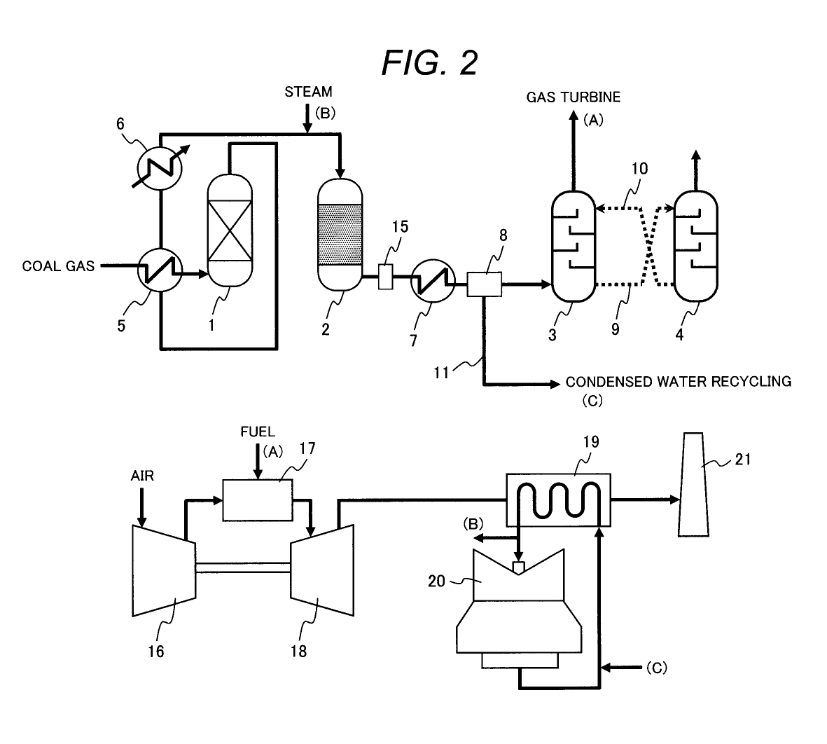

Next, a method/system of gas purification according to the present invention will be illustrated in detail by taking, as an example, an integrated coal gasification combined cycle power plant to which an embodiment of the present invention is applied. FIG. 2 is a block flow diagram of the integrated coal gasification combined cycle power plant system to which an embodiment of the present invention is applied.

The gas purification system according to this embodiment includes a flushing tower 1, a shift reactor 2, a H₂S/CO₂ simultaneous absorption tower 3, and a regeneration tower 4 as principal components.

The shift reactor 2 is charged with a shift catalyst and performs a shift reaction. The shift catalyst used herein may be, but is not limited to, a shift catalyst including a TiO₂ support and, supported thereon, P, Mo, and Ni.

The H₂S/CO₂ simultaneous absorption tower 3 employs a liquid absorbent to absorb H₂S and CO₂. The liquid absorbent will be described later.

A gasified gas (coal gas) formed in a gasification furnace (not shown) is fed through a heat exchanger 5 to the flushing tower 1 and is cleaned therein. Specifically, impurities such as heavy metals and hydrogen halides are removed from the gasified gas in the flushing tower 1.

The gasified gas cleaned in the flushing tower 1 is fed to the shift reactor 2. In the midway to the shift reactor 2, the gasified gas is heated by the heat exchanger 5 and a gas-heater 6 up to a reaction temperature for the shift catalyst. The heating heats the gasified gas to a temperature of about 200° C. to about 400° C. at the inlet of the shift reactor 2. In a preferred embodiment, the gasified gas heated to a temperature of about 200° C. to about 300° C. is brought into contact with the catalyst. This temperature range is demonstrated by the test results in FIG. 10.

A gasified gas at the inlet of the shift reactor 2 in a steady operation mainly contains CO and H₂ and contains, in dry volume percent, about 60 percent by volume of CO and about 25 percent by volume of H₂. The shift reaction is a hydrolysis reaction as represented by Formula (1), and the gas purification system further includes a steam supply tube upstream from the shift reactor 2 so as to supply steam in a predetermined amount to the gasified gas steadily. Part of steam generated in a heat recovery steam generator 19 is extracted and used as the steam to be supplied to the shift reaction. In this embodiment, the steam is extracted at the outlet of the heat recovery steam generator 19, but the steam may be extracted in a midway stage of a steam turbine 20. The gasified gas with the supply of steam undergoes a CO shift reaction by the catalysis of the shift catalyst in the shift reactor 2.

The coal gas contains a trace amount of COS. The gas purification system according to the embodiment converts both CO and COS in the shift reactor without separately providing a COS converter, as described above.

A gas discharged from the shift reactor 2 is cooled by a heat exchanger 7. Water in the gas is condensed by a knockout drum 8 serving as a condenser and removed from the gas. The gas purification system according to the embodiment further includes an alcoholysis catalyst 15 upstream from the heat exchanger 7 by which the gas is cooled. The alcoholysis catalyst 15 removes side products from the gas and thereby reduces the concentrations of water-soluble substances contained in the condensed water. The alcoholysis catalyst used herein may be a Zn—Cu catalyst. A methanol reforming catalyst, such as a Cu—Zn catalyst, may be arranged instead of the alcoholysis catalyst. The alcoholysis catalyst 15 can naturally be omitted when the concentrations of water-soluble substances in the condensed water are sufficiently low.

The gas is subsequently fed to the H₂S/CO₂ simultaneous absorption tower 3, from which H₂S and CO₂ are removed by the action of the liquid absorbent. H₂ which has not been absorbed by the liquid absorbent is discharged from the H₂S/CO₂ simultaneous absorption tower 3 and supplied as a fuel to a gas turbine system. The gas turbine system includes an air compressor 16, a combustor 17, and a gas turbine 18. An exhaust gas which has been used for driving the gas turbine 18 is fed to a heat recovery steam generator 19 and discharged from a smokestack 21. A power generator is not shown in the figure.

The liquid absorbent absorbing H₂S and CO₂ (rich solution) is fed through a rich solution passage 9 to the regeneration tower 4 and thermally regenerated therein. After the thermal regeneration, H₂S is discharged and converted into gypsum by the action of a calcium-containing absorbent; whereas CO₂ is recovered by liquefaction and solidification. The regenerated liquid absorbent (lean solution) is fed through a lean solution passage 10 to the H₂S/CO₂ simultaneous absorption tower 3 and used for the absorption of H₂S and CO₂ from the gas. This embodiment employs the flushing tower 1 arranged upstream from the shift reactor 2 to remove heavy metals and hydrogen halides from the gasified gas. The catalyst to be used in the shift reactor 2 can be poisoned by heavy metals and hydrogen halides, if entering the shift reactor. To avoid this, heavy metals and hydrogen halides are preferably removed upstream from the shift reactor 2.

In this embodiment, a flushing tower, i.e., wet removal equipment, is exemplified as equipment for removing heavy metals and hydrogen halides, but dry removal equipment using an adsorbent or absorbent may also be used. The absorbent or absorbent is typified by oxides, carbonates, and hydroxides of alkali metals and alkaline earth metals; and porous substances such as activated carbon and zeolite. Such dry removal equipment, when used, can save operations for cooling and heating the gasified gas and thereby save energy loss. In contrast, a flushing tower acting as wet removal equipment, when used, is expected to allow entrained steam from the flushing tower to be mixed with the gasified gas, and this advantageously reduce the steam supply to be supplied at the inlet of the shift reactor 2.

The H₂S/CO₂ simultaneous absorption tower 3 can be any of a physical absorption tower and a chemical absorption tower. The H₂S/CO₂ simultaneous absorption tower 3 may have a structure similar to that of a customary CO₂ absorption tower and absorbs both H₂S and CO₂ using one liquid absorbent. The liquid absorbent is typified by SELEXOL® and Rectisol® for physical absorption; and methyldiethanolamine (MDEA) and ammonia for chemical absorption.

This embodiment employs a system for the regeneration of the liquid absorbent using the regeneration tower 4, which liquid absorbent has absorbed H₂S and CO₂ in the H₂S/CO₂ simultaneous absorption tower 3. The regeneration of the liquid absorbent may employ, instead of the system using the regeneration tower, a flash regeneration system utilizing pressure swing, or a system of flash regeneration in combination with regeneration using a regeneration tower. The flash regeneration, when employed, enables separate recovery of H₂S and CO₂ and enables recovery of high-purity CO₂.

This embodiment employs a condensed water recycling pipe 11 arranged in the knockout drum 8. The condensed water recycling pipe 11 is a pipe for recycling condensed water formed after the shift reaction to another use in the system without discharging from the system. The system according to the embodiment uses the condensed water as part of water to be supplied to the heat recovery steam generator 19. The post-shift condensed water, when containing large amounts of water-soluble substances, may be cleaned by a common water treatment process, such as membrane cleaning, ozonolysis, or precipitation/filtration using a flocculant, before recycling.

Exemplary uses of the recycled water include water to be supplied to a steam generator for the generation of steam for power generation; and water to be supplied to a flushing tower for the removal of impurities from the coal gas. The recycled water can also be used in any other use than those described in the present description, as long as the recycled water remains in the system. The recycled water (condensed water) may be subjected to a suitable water treatment according to the cleanliness thereof as required in a facility to which the water is recycled.

This embodiment enables recycling (reuse) of a post-shift condensed water without discharging from the system and provides a recycling system to reduce environmental loads. The embodiment reduces the steam supply to be supplied to a shift step in a coal gasification plant and suppresses reduction in power generation efficiency due to CO₂ recovery. In addition, the embodiment significantly reduces the water treatment cost through reduction in post-shift condensed water and reduction in amounts of water-soluble substances in the condensed water.

### Second Embodiment

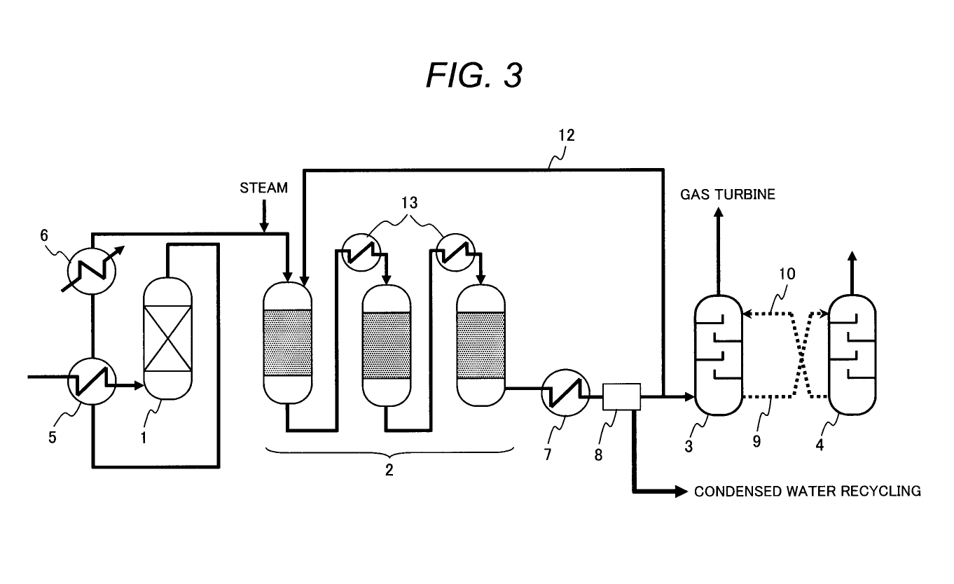

Next, a method/system of gas purification according to another embodiment of the present invention will be illustrated below. FIG. 3 is a block flow diagram of a gas purification system according to Second Embodiment of the present invention. Reference signs in FIG. 3 identical to those in FIG. 2 represent the same or common elements as in FIG. 2. Components such as a gas turbine system, a heat recovery steam generator, and a steam turbine are not shown in the figure.

The gas purification system according to this embodiment includes two or more shift reactors. Specifically, such multistage shift reactor features the gas purification system. The gas purification system illustrated in FIG. 3 includes three shift reactors 2. While not employed in this embodiment, the system may further include an alcoholysis catalyst 15 as in the embodiment illustrated in FIG. 2.

The shift reactor 2 is configured to have a multistage structure because the reaction represented by Formula (1) is an exothermic reaction and, if the shift reactor 2 has a single-stage structure, the temperature in the shift reactor may significantly rise. Such significant temperature rise in the shift reactor may cause deterioration of the charged catalyst and reduction of specific surface area due typically to sintering, thus resulting in a lower catalytic activity. In addition, the temperature rise in the shift reactor may impair materials of the shift reactor itself. For these reasons, the shift reactor preferably has a multistage structure. The multistage shift reactors 2 allow CO shift reactions to proceed sequentially and thereby suppress overheating of the catalyst and the shift reactor 2.

The shift reactor 2 in the embodiment illustrated in FIG. 3 has a three-stage structure (including three reactors), but the number of stages is not limited to three, and any number of stages will do, as long as being two or more.

The system according to this embodiment includes two heat exchangers 13 arranged respectively upstream from a downstream shift reactor. This arrangement is employed for recovering heat generated in an upstream shift reactor 2 so as to lower the temperature of the inlet of a downstream shift reactor 2, and such efficient heat recovery suppresses reduction in power generation efficiency. Typically, recovery of heat for the generation of steam to be supplied to the shift reactor can reduce the steam amount to be extracted from the steam turbine system side and thereby protect the steam turbine from having a low power generation efficiency.

The system according to this embodiment includes a recycling pipe 12 that connects between the outlet side of a knockout drum 8 and the upstreammost shift reactor 2 to recycle part of a downstream gas from the knockout drum 8 to the upstreammost shift reactor. Specifically, the recycling pipe 12 connects between the downstream side from the downstreammost shift reactor 2 and the inlet of the upstreammost shift reactor 2 and thereby supplies and recycles part of the gasified gas from the downstreammost shift reactor 2 to the upstreammost shift reactor 2. The gas to be recycled is a gas after the CO shift reaction and has a CO₂-rich gaseous composition.

Recycling and supply of such CO₂-rich gas having a large heat capacity to the upstreammost shift reactor 2 suppresses the temperature rise of the upstreammost shift reactor 2 where the CO shift reaction most readily proceeds to cause significant temperature rise. This also slows down the CO shift reaction and enables efficient utilization of the downstream two shift reactors 2.

This embodiment advantageously provides an efficient CO shift reaction and suppresses deterioration in materials of the shift reactors and of the catalyst charged in the shift reactors, in addition to having advantageous effects of First Embodiment.

The recycling pipe 12 is applicable not only to a gas purification system including multiple shift reactors as in this embodiment but also to a gas purification system including a single shift reactor 2 as in First Embodiment (FIG. 2).

The respective embodiments according to the present invention have been described as being applied to integrated coal gasification combined cycle power plants, but they are also applicable with similar advantageous effects to coal gasification plants for the production of H₂ as a starting material for chemical products; and to coal gasification plants for the production of H₂ for steel making through hydrogen reduction.

While the present invention has been described with reference to its preferred embodiments, it is to be understood that the invention is not limited thereto but may be otherwise variously embodied within the scope of the invention. Typically, the embodiments have been described in detail so as to illustrate the present invention clearly, and the present invention is not limited to ones including all the described configurations. Substitution of part of a configuration of one embodiment with a configuration of another embodiment is possible; and addition of a configuration of one embodiment to a configuration of another embodiment is also possible. Additions, deletions, and substitutions of part of a configuration of an embodiment with or by another configuration can also be made.

Water and steam flows and heat exchange have been described, as long as being necessary for the sake of explanation. All water and steam flows and heat exchanges in the plant are not always described. Various modifications and improvements in water and steam flows and heat exchange operations are made in actual plants.

### REFERENCE SIGNS LIST

1 flushing tower
2 shift reactor
3 H₂S/CO₂ simultaneous absorption tower
4 regeneration tower
5, 7, 13 heat exchanger
6 gas heater
8 knockout drum
9 rich solution passage
10 lean solution passage
11 condensed water recycling pipe
12 gas recycling pipe.

1. A method of gas purification, comprising:
a cleaning step of removing a water-soluble substance from a gasified gas gasified from a carbon-containing solid fuel;
a CO shift step of allowing CO in a gas from the cleaning step to react with steam in the presence of a sulfur-tolerant shift catalyst hardly causing a side reaction, and thereby converting the CO into CO₂ and H₂;
a recovery step of removing and recovering CO₂ and H₂S from a gas from the CO shift step; and
a recycling step of recycling condensed water derived from steam having been subjected to a shift reaction in the CO shift step.

2. The method of gas purification of claim 1, wherein a shift catalyst comprising nickel (Ni) and molybdenum (Mo) as catalytic components is used as the shift catalyst.

3. The method of gas purification of claim 2, wherein the condensed water is recycled to be supplied to a steam generator.

4. The method of gas purification of claim 2, wherein the gasified gas and the shift catalyst are brought into contact with each other at a temperature of 200° C. to 300° C. in the CO shift step.

5. The method of gas purification of claim 2, wherein the amount of steam is controlled in the CO shift step so that a molar ratio of H₂O to CO(H₂O/CO) be from 1.2 to 1.8.

6. The method of gas purification of claim 2, wherein the CO shift step is performed in multiple substeps.

7. A coal gasification plant comprising:
a coal gasification furnace;
a gasified gas cleaning system arranged downstream from the coal gasification furnace;
a shift reactor arranged downstream from the gasified gas cleaning system and filled with a sulfur-tolerant CO shift catalyst hardly causing a side reaction;
a steam generator that generates steam to be supplied to the shift reactor;
a condenser that is arranged downstream from the shift reactor and condenses steam in a gas from the shift reactor;
a recovery system that is arranged downstream from the condenser and removes CO₂ and H₂S from a gas from the condenser; and
a condensed water recycling pipe that connects the condenser to a system in which condensed water is reused.

8. The coal gasification plant of claim 7, further comprising an alcoholysis catalyst or an ethanol reforming catalyst arranged between the shift reactor and the condenser.

9. The coal gasification plant of claim 7,
wherein the coal gasification plant comprises two or more of the shift reactor;
the coal gasification plant further comprises a gas recycling pipe that connects a downstream area of a downstreammost shift reactor and an inlet of an upstreammost shift reactor, of the two or more shift reactors, to supply part of a gas discharged from the downstreammost shift reactor to the upstreammost shift reactor.

10. A shift catalyst for accelerating a shift reaction in which CO in a H₂S-containing gas is allowed to react with H₂O and is converted into CO₂ and H₂, the shift catalyst comprising:
a support; and
at least molybdenum (Mo), nickel (Ni), and phosphorus (P) each supported on the support.

11. The shift catalyst of claim 10,
wherein the support comprises an inorganic oxide containing TiO₂.

12. The shift catalyst of claim 11,
wherein the shift catalyst has a mole number of metal titanium in TiO₂ of Ma and a mole number of metal molybdenum of Mc; and
a molar ratio of Mc to Ma [(Mc)/(Ma)] is from 0.1 to 0.5.

13. The shift catalyst of claim 11,
wherein the shift catalyst has a mole number of metal titanium in TiO₂ of Ma and a mole number of metal nickel of Mb; and
a molar ratio of Mb to Ma [(Mb)/(Ma)] is from 0.05 to 0.3.

14. The shift catalyst of claim 12,
wherein the shift catalyst has a mole number of metal titanium in TiO₂ of Ma and a mole number of metal nickel of Mb; and
a molar ratio of Mb to Ma [(Mb)/(Ma)] is from 0.05 to 0.3.

15. The shift catalyst of claim 11,
wherein the shift catalyst has a mole number of metal titanium in TiO₂ of Ma and a mole number of phosphorus of Md; and
a molar ratio of Md to Ma [(Md)/(Ma)] is from 0.01 to 0.02.

16. The shift catalyst of claim 12,
wherein the shift catalyst has a mole number of metal titanium in TiO₂ of Ma and a mole number of phosphorus of Md; and
a molar ratio of Md to Ma [(Md)/(Ma)] is from 0.01 to 0.02.

17. The shift catalyst of claim 13,
wherein the shift catalyst has a mole number of metal titanium in TiO₂ of Ma and a mole number of phosphorus of Md; and
a molar ratio of Md to Ma [(Md)/(Ma)] is from 0.01 to 0.02.

18. The shift catalyst of claim 14,
wherein the shift catalyst has a mole number of metal titanium in TiO₂ of Ma and a mole number of phosphorus of Md; and
a molar ratio of Md to Ma [(Md)/(Ma)] is from 0.01 to 0.02.
